(19) United States
(12) Patent Application Publication
(10) Pub. No.: US 2009/0217905 A1
(43) Pub. Date: Sep. 3, 2009

(54) DIRECT INJECTION TYPE OF DIESEL ENGINE

(75) Inventors: Daijiro Tanaka, Shizuoka-ken (JP); Naoki Onda, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/813,385

(22) PCT Filed: Dec. 27, 2005
(86) PCT No.: PCT/JP2005/023900

§ 371 Date: May 2, 2008

(30) Foreign Application Priority Data
Jan. 5, 2005 (JP) 2005-000650

(51) Int. Cl. F02F 3/26; F01L 1/34

(52) U.S. Cl. 123/276; 123/90.15

(57) ABSTRACT

A center cavity made up of a generally circular recess is formed in a head of a piston. An injector is provided for injecting fuel into the center cavity. Sub-cavities are connected to the center cavity on the periphery side of the head. The injector is positioned to inject fuel to a border portion between the sub-cavities and the center cavity.

### CROSS-REFERENCE TO RELATED APPLICATIONS

This application is a U.S. National Phase Application of International Application No. PCT/JP2005/23900, filed Dec. 27, 2005, which is based upon and claims priority to Japanese Patent Application No. 2005-000650, filed Jan. 5, 2005, each of which is hereby incorporated by reference in its entirety.

### BACKGROUND OF THE INVENTION

1. Field of the Invention

This invention relates to a direct injection type of diesel engine provided with an injector for injecting fuel directly into a center cavity in a piston head.

2. Description of the Related Art

Conventionally, direct injection diesel engines for passenger cars, for example, have been required to have higher output and cleaner exhaust emissions. To meet such requirements, improvements in combustion have been attempted by forming a combustion chamber in the piston.

In one such piston, the piston has a round recess, which is called the center cavity, in the center (i.e., the axial center) portion of the piston head. The direct injection type of diesel engine having such a piston has the injector positioned so that its nozzle faces the interior of the center cavity of the piston near top dead center to inject fuel to the inside wall of the center cavity.

In another such piston, the opening of the center cavity is formed with a smaller inside diameter than the other portion, with the opening formed in a so-called inside flange shape. Forming the opening part relatively narrow in this way is thought to improve combustion because a wider squish area is formed between the piston head and the cylinder head.

In conventional diesel engines for automobile use, the pistons are either provided with no recess or, if a recess is provided, with a very shallow recess.

### SUMMARY OF THE INVENTION

However, even the above-described direct injection diesel engines require further improvement in output, fuel consumption, and purification of exhaust emissions. The conventional diesel engines for automobile use seem to be configured with importance placed on purification of exhaust emissions, and the pistons are provided either with no recess or, if provided, with a very shallow recess. With such conventional direct injection diesel engine for automobile use, it has been difficult if not impossible to improve torque at low revolutions by elongating the valve overlap of the intake and exhaust valves.

Therefore, one feature, aspect or advantage of an embodiment of the present invention is to provide a direct injection diesel engine that obtains improved output and purified exhaust emissions while also improving fuel economy. In one embodiment, the direct injection diesel engine includes a piston with a center cavity comprising a circular recess formed in its head and an injector that injects fuel directly into the center cavity. In addition, sub-cavities are formed in the peripheral sides of the head and are connected to the center cavity. The injector is positioned to inject fuel toward a border portion defined between the sub-cavities and the center cavity.

### BRIEF DESCRIPTION OF THE DRAWINGS

These and other features, aspects and advantages of the present invention will now be described with reference to the drawings of preferred embodiments, which embodiments are intended to illustrate and not to limit the invention. The drawings consist of 12 figures.

FIG. 1 is a partial sectioned view of a cylinder body of a direct injection diesel engine.

FIG. 2 is a plan view of a piston head used in the embodiment of FIG. 1.

FIG. 3 is an enlarged sectioned view of the piston head.

FIG. 4A shows timing of opening and closing intake and exhaust valves in low speed operation.

FIG. 4B shows timing of opening and closing intake and exhaust valves in high speed operation.

FIG. 5 is a graph of a relationship between torque and engine revolution of the direct injection diesel engine of FIG. 1.

FIG. 6 is a graph of a relationship between air-to-fuel ratio, smoke amount, and engine revolution of the direct injection diesel engine of FIG. 1.

FIG. 7 is a plan view of another piston head.

FIG. 8 is a plan view of a further piston head.

FIG. 9 is a plan view of an additional piston head.

FIG. 10 is a plan view of a piston head.

FIG. 11 is a plan view of a piston head.

### DETAILED DESCRIPTION OF THE PREFERRED EMBODIMENT

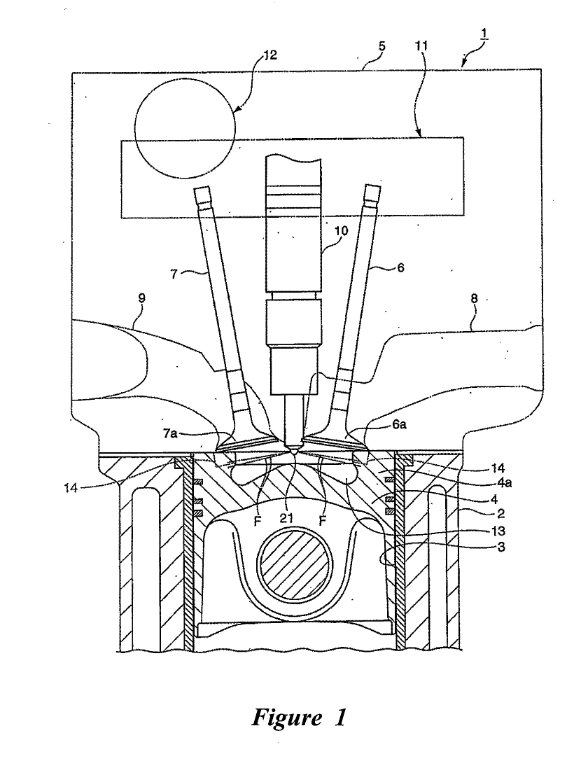

A direct injection diesel engine 1 is described below in reference to FIGS. 1 through 6. FIG. 1 is a partially sectioned view of a cylinder body of a direct injection diesel engine 1 that is arranged and configured in accordance with certain features, aspects and advantages of the present invention. The diesel engine 1 is a water-cooled, multi-cylinder type and can be configured to be mounted on automobiles. In addition, the direct injection diesel engine may be used as a vehicle engine for other vehicles, including passenger cars, buses, trucks, and the like, or as an industrial engine for generators or the like. The illustrated direct injection diesel engine 1, like diesel engines in general, has its output controlled by the amount of fuel that is supplied to the engine.

The diesel engine 1 comprises a cylinder body 2 with a plurality of cylinders in a lateral row, pistons 4 inserted for free motion within corresponding cylinder bores 3 of the cylinder body 2, and a cylinder head 5 attached to the cylinder body 2. On the cylinder head 5, two intake valves 6 and exhaust valves 7 are provided for each cylinder (one each of the intake and exhaust valves is not shown), and intake passages 8 and exhaust passages 9 are opened and closed with these intake and exhaust valves 8, 9. An injector 10 is attached to the cylinder head 5 on the cylinder axis. The intake and exhaust valves 6, 7 are connected to a valve drive mechanism 11 having intake camshafts and exhaust camshafts (not shown). Although not shown, a turbocharger can be connected to the downstream side of the exhaust passage 9 of the cylinder head 5. The exhaust passage 9, as is well known, is configured to use the exhaust pulsation effect. For example, the exhaust passage 9 may be configured so that the pressure at the opening on the combustion chamber side is lower than that on the intake side during a valve overlap time.

The intake camshaft and exhaust camshaft are connected to a crankshaft (not shown) through a transmitting mechanism and rotate with the rotation of the crankshaft, which is transmitted through the transmitting mechanism. A variable valve timing device 12 can be interposed between the exhaust camshaft and the transmitting mechanism in a torque transmitting system. The variable valve timing device 12 can be configured to advance and delay the phase of the exhaust camshaft relative to the phase of the transmitting mechanism when the exhaust camshaft rotates.

In one preferred configuration, the variable valve timing device 12 can continuously change the phase of the exhaust camshaft. As the variable valve timing device 12, a construction that advances or delays the phase of the exhaust camshaft by the so-called on-off operation may be used. As the variable valve timing device 12, another construction that changes individually the opening time and the closing time of the exhaust valve 7 may also be used.

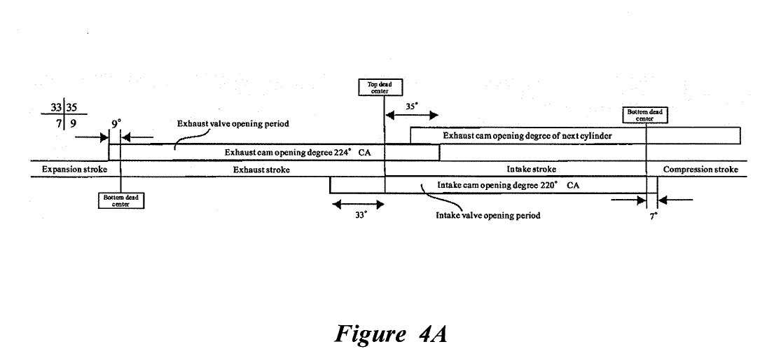

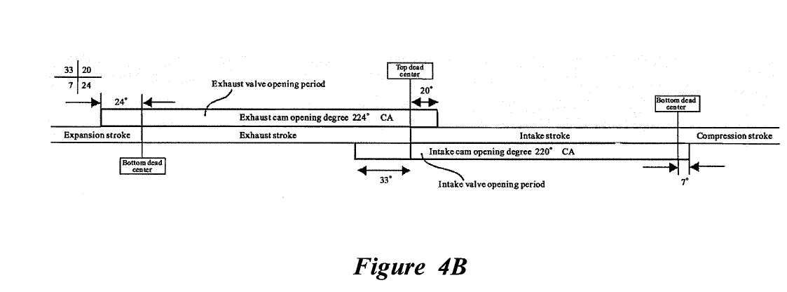

With reference to FIG. 4, the exhaust cam of the illustrated camshaft is formed so that the opening degree (i.e., the crankshaft rotation angle during a period while the exhaust valve remains open) is about 224 degrees. On the other hand, the opening degree of the intake cam is set to about 220 degrees. The variable valve timing device 12 is configured to change the phase of the exhaust camshaft rotation between a delayed angle state (e.g., that shown in FIG. 4A) and an advanced angle state (e.g., that shown in FIG. 4B).

The variable valve timing device 12 is in the delayed angle state shown in FIG. 4A when the engine is in the low speed operation range, and moves to the advanced angle state shown in FIG. 4B continuously or by the so-called on-off operation while the operation range moves from the low speed operation range to the high speed operation range.

In the delayed angle state shown in FIG. 4A, the exhaust valve 7 opens when the piston 4 is at about 9 degrees before bottom dead center and closes at about 35 degrees after top dead center. The intake camshaft preferably is formed so that the intake valve 6 opens when the piston 4 is at about 33 degrees before top dead center and the intake valve 6 closes at about 7 degrees after bottom dead center, whether in the delayed angle state or the advanced angle state.

In the advanced angle state shown in FIG. 4B, the exhaust valve 7 preferably opens when the piston 4 is at about 24 degrees before bottom dead center and closes at about 20 degrees after top dead center. In other words, the variable valve timing device 12 of this embodiment preferably advances or delays the exhaust camshaft rotation angle by about 15 degrees between the advanced angle state and the delayed angle state.

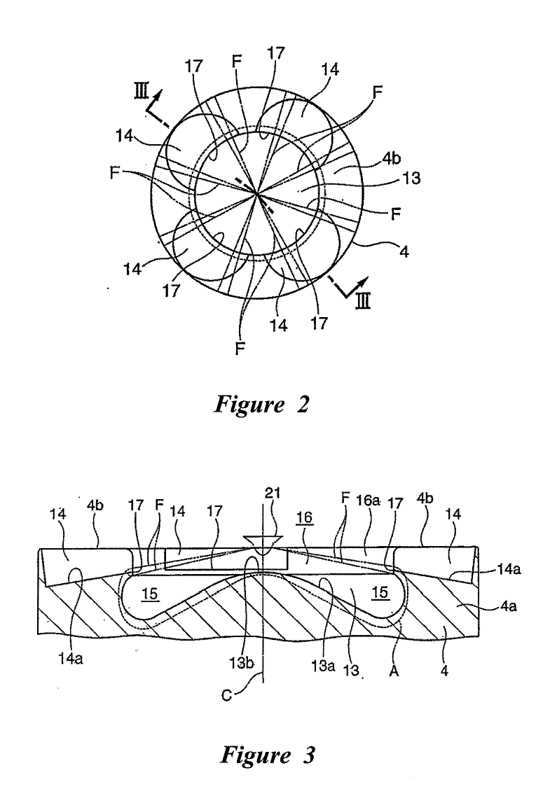

With reference to FIGS. 2 and 3, a center cavity 13, which is located in the central area (e.g., around the axis of the piston 4), can be formed in the head portion 4a of the piston 4. In addition, sub-cavities 14 preferably are located in four positions on the periphery of the center cavity 13.

The center cavity 13 preferably is a round recess centered on the axis C of the piston 4. The center cavity 13 can comprise a bottom portion 15 with its inside round surface formed in an arcuate shape in vertical section. The center cavity 13 also can comprise an opening portion 16 with its inside diameter substantially constant and extending in the axial direction of the piston 4. The inside diameter of the opening portion 16 can be smaller than the maximum diameter of the bottom portion 15 (i.e., the inside diameter within the center cavity 13). The bottom 13a of the center cavity 13 can be quasi conical in shape such that it is convex toward the cylinder head 5.

The sub-cavities 14 in this embodiment are recesses provided in parts of the head 4a of the piston 4 facing the valve bodies 6a, 7a (see FIG. 1) of the intake and exhaust valves 6, 7. The sub-cavities 14 are formed, in parts of the recess facing the valve bodies 6a, 7a of the intake and exhaust valves 6, 7, deeper and greater in radial direction than the recess and exhibiting a similar shape to a part of the valve bodies 6a, 7a. In one preferred configuration, the opening shape of the sub cavities 14, as shown in FIG. 2, is formed in a shape into which the valve bodies 6a, 7a of the intake and exhaust valves 6 and 7 may be inserted deep, as if in a loose fit state. The bottom surface 14a of the sub-cavities 14 is formed, as shown in FIG. 3, at about the same height as the apex 13b of the bottom 13a of the center cavity 13.

Forming the sub-cavities 14 in the head 4a of the piston 4 as described above causes the bottom surface 14a of each sub-cavity 14 to be connected to the inside round surface 16a of the opening 16 of the center cavity 13 through a border portion 17, which is generally arcuate in shape in a plan view.

In the piston 4 of this embodiment, as shown in FIG. 2, a flat surface defines the bottom of the squish area between the adjacent sub-cavities 14 on the peripheral portions of the piston head surface 4b.

It is conceivable that forming the sub-cavities 14 in the head 4a of the piston 4 as described above may result in a decreased compression ratio. However, the piston 4 of the illustrated embodiment greatly reduces the likelihood of a decrease in the compression ratio by reducing the volume of the center cavity 13. In other words, in the piston 4 of the illustrated embodiment, a specified compression ratio value is obtained by forming the inside surface of the center cavity, which conventionally is formed in the shape indicated with the broken line A in FIG. 3, in the shape indicated with the solid line in the figure so that the cavity volume is reduced.

The injector 10, as shown in FIG. 1, preferably is secured to the cylinder head 5 such that a fuel injection nozzle 21 provided at the distal end projects from the cylinder head 5 toward the cylinder body 2. In one configuration, the fuel injection nozzle 21 injects in eight directions, to be described later, as shown in double-dotted chain lines in FIGS. 1 to 3, such that it defines a generally conical shape having a small apex angle. With reference to FIGS. 1 to 3, each direction of fuel injection extends toward the border portion 17 between the center cavity 13 and the sub-cavity 14.

With reference to FIG. 2, the illustrated fuel injection nozzle 21 uses a configuration in which fuel is injected to two positions of each of the four border portions 17, as seen in the axial direction of the piston 4, between the center cavity 13 and the four sub-cavities 14. In other words, this nozzle 21 injects fuel in directions that divide the periphery of the piston 4 into eight segments as seen in the axial direction of the piston 4 or in directions directed to two positions of each of the four border portions 17.

Injecting fuel from the fuel injection nozzle 21 to the border portions 17 as described above distributes the injected fuel into the center cavity 13 and the sub-cavities 14. Preferably, the injector 10 injects fuel immediately before the piston 4 reaches top dead center at the end period of the compression stroke. As a result, most of the fuel injected through the nozzle 21 strikes the border portions 17 and is distributed to the center cavity 13 and the sub-cavities 14. The injected fuel preferably is ignited while being mixed with air within both of the cavities 13, 14.

The center cavity 13 and the sub-cavities 14 of the illustrated configuration comprise a wide combustion chamber in that fuel is distributed into the center cavity 13 and the sub-cavities 14. As a result, the illustrated engine 1 is capable of almost completely burning the injected fuel by efficiently using a relatively increased amount of air in the combustion chamber. Because combustion is improved, the illustrated configuration makes it possible to obtain higher output while realizing low fuel consumption. Being generally free from incomplete combustion also reduces the amount of black smoke produced.

As shown in FIG. 6, which reflects the outcome of testing, the amount of black smoke produced has been decreased in comparison with having fuel injected only into the center cavity 13. In FIG. 6, the solid lines represent when fuel is injected into only the center cavity 13 of the illustrated piston 4 and the broken lines represent when fuel also is injected to the border portions 17. As is clear from FIG. 6, when fuel is injected to the border portions 17, in spite of lower (i.e., thicker) air-to-fuel ratio in comparison with the case in which fuel is injected only into the center cavity 13, the amount of smoke (black smoke) produced has proven to be less. From these data, too, it becomes apparent that combustion in the direct injection diesel engine 1 occurs with good efficiency.

When the piston 4 reaches top dead center in a compression stroke, air flows at a high speed from the squish area formed between the piston 4 and the cylinder head 5 into the center cavity 13 and the sub-cavity 14. With the illustrated piston 4, because the inside diameter of the opening 16 of the center cavity 13 is formed small and a wide squish area is formed, the amount of air blowing out of the squish area is great, and this air makes it possible to further improve combustion. The bottom surface 14a of the sub-cavity 14 is formed in a deep position to be nearly at the same height as the apex 13b of the bottom 13a of the center cavity 13, which increases the volume of the sub-cavity 14. As a result, as described above, it is possible to positively mix air blowing out of the squish area at high speeds with fuel within the sub-cavity to further improve combustion.

In the illustrated direct injection diesel engine 1, when fuel burns, the piston moves in an expansion stroke, and the piston 4, near the end period of the subsequent exhaust stroke, reaches a position at about 33 degrees before top dead center. At this point, the intake valve 6 preferably opens. The period of valve overlap in which the intake valve 6 and the exhaust valve 7 are simultaneously open becomes relatively long (e.g., about 68 degrees in FIG. 4A in this example) when the engine is in a low speed operation range and relatively short (e.g., about 53 degrees in FIG. 4B in this example) when the engine is in a high speed operation range.

In the illustrated direct injection diesel engine 1, pressure in the intake passage 8 during valve overlap is higher than the negative pressure in the exhaust passage 9, which is a result of the exhaust pulsation effect, whether the intake device of the engine is of a turbo-supercharging type or natural intake type. As a result, during the valve overlap, the pressure difference between the pressure in the intake passage 8 (e.g., supercharge pressure or atmospheric pressure) and the pressure in the exhaust passage 9 causes fresh air to flow through the intake passage 8 into the combustion chamber so as to scavenge the combustion byproducts.

The amount of fresh air inflow is greater when the valve overlap is longer. Therefore, as this diesel engine 1 is adapted to increase the amount of intake air by elongating the valve overlap in low speed operation, torque at low speeds is increased by providing the sub-cavity 14 as described above. Further, because the illustrated sub-cavity 14 is deeper than the recess formed in the piston 4, it is possible to increase the opening degree of the intake and exhaust valves 6, 7 during the valve overlap, so that air flow occurs smoothly.

Further, the diesel engine of this embodiment, in spite of the valve overlap exceeding 60 degrees, unlike gasoline engines, is generally free from adverse effects on the amount of black smoke emission and fuel economy at partial load. In gasoline engines in general, a longer valve overlap causes exhaust gas to flow back into the intake system under negative pressure to deteriorate combustion. However, because there is no throttle valve in diesel engines, negative pressure does not occur in the intake system, and so no reverse flow of exhaust gas occurs into the intake system. The combustion in the diesel engine is the so-called diffused combustion with ignition occurring at dispersed positions within the combustion chamber. Therefore, even if reverse exhaust gas flow into the intake system occurs in the diesel engine, unlike in the gasoline engine in which combustion occurs with uniform mixture, such an internal EGR does not become a problem.

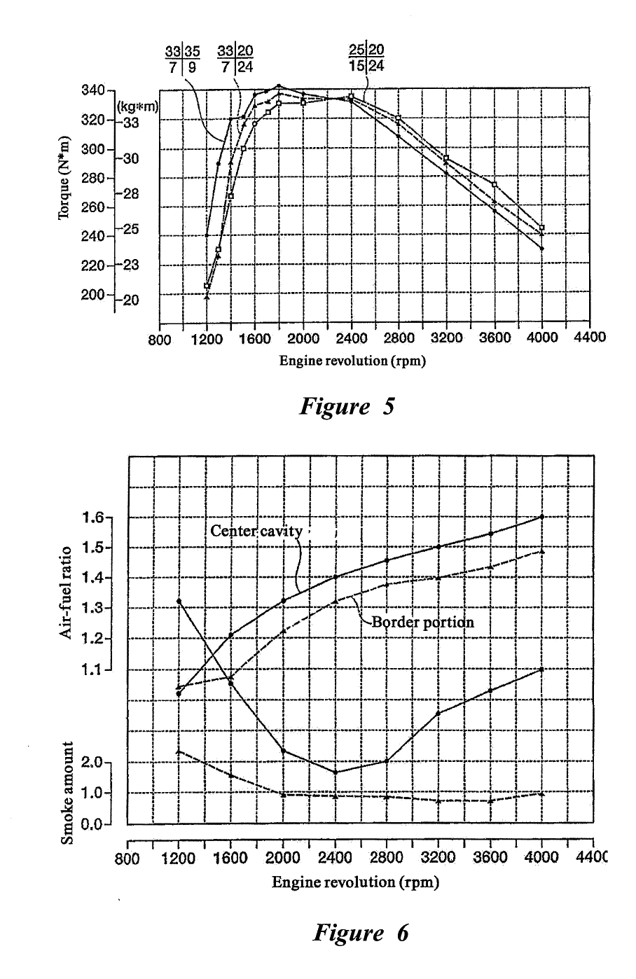

The torque of the diesel engine 1 varies as indicated with solid lines in FIG. 5 in the low speed operation state in which the valve overlap is the longest as described above or as shown in FIG. 4A in the state in which the exhaust valve 7 opens at about 9 degrees before bottom dead center and closes at about 35 degrees after top dead center. In FIG. 5, the broken line indicates the change in torque in the state of the shortest valve overlap or the state in which the exhaust valve 7 opens at about 24 degrees before bottom dead center and closes at about 20 degrees after top dead center. The single-dotted chain line indicates the torque change in the state in which the valve overlap is made the shortest and further the intake camshaft is replaced with one that delays the rotation phase by about 8 degrees (i.e., one that further shortens the overlap) in comparison with the illustrated intake camshaft.

As shown in FIG. 5, the illustrated direct injection diesel engine 1 produces relatively great torque by increasing the valve overlap when the engine speed is lower than about 2200 rpm. When the engine speed is higher than about 2200 rpm and the valve overlap is long, the torque becomes relatively small. Therefore, in one configuration, the variable valve timing device 12 delays the phase angle of the exhaust camshaft in low engine speed operation of the engine (e.g., about 2200 rpm or lower), and the phase angle of the exhaust camshaft is advanced in high engine speed operation of the engine (e.g., about 2200 rpm or higher). Incidentally, the variable valve timing device 12 may be made to have hysteresis in its action so that the variable valve timing device 12 does not repeat moving between advanced and delayed angle state when the engine revolution changes up and down around the 2200 rpm.

When the diesel engine 1 reaches the high speed operation range and the variable valve timing device 12 causes the camshaft phase to move from the delayed angle side shown in FIG. 4A to the advanced angle side shown in FIG. 4B, the opening time of the exhaust valve 7 becomes earlier, so that an exhaust gas is discharged into the exhaust passage 9 from the middle of expansion stroke. When this occurs, the pressure in the cylinder relatively lowers when the stroke moves from expansion to exhaust, so as to reduce pumping loss, improve fuel economy in high speed operation, and increase output.

Incidentally, when an attempt is made, without using the variable valve timing device 12, to elongate the valve overlap while opening the exhaust valve 7 at an earlier time by making the exhaust cam opening longer than about 224 degrees, for example about 256 degrees, the simultaneous opening period of the exhaust valve 7 of other cylinder becomes longer during the valve overlap. Therefore, when such a constitution is employed, exhaust gas of other cylinders may blow down during the valve overlap. In other words, exhaust gas of a high pressure flows in when the exhaust valve starts opening, and intake air cannot flow smoothly into the combustion chamber, undesirably resulting in a remarkable reduction in low speed torque.

As the direct injection type of diesel engine 1 of this embodiment uses a cam with a small opening period of the exhaust valve 7 of about 224 degrees in combination with the exhaust variable timing device 12, it is possible to make as short as possible the period in which exhaust valves 7 of two cylinders are open simultaneously (see FIG. 4A). Therefore, it is possible to minimize the amount of exhaust inflow from other cylinders into the exhaust passage 9 due to exhaust blow-down in other cylinders. Using the exhaust cam with the small opening degree is also one factor in improving the intake efficiency as described above.

The direct injection type of diesel engine 1 of the illustrated embodiment makes it possible to lower the engine speed at which a maximum torque is produced down to about 1500 rpm by changing the valve overlap period. Producing the maximum torque at low revolutions in this way makes it possible to shorten the time lag (i.e., the turbo lag) of the engine speed rising to a speed at which the effect of a turbocharger is obtained efficiently. It also helps to obtain high acceleration performance.

In the illustrated direct injection diesel engine 1, as the intake ability at low speed is improved, supercharged pressure need not be increased, and a turbo-compressor may be used on the lower pressure side of a surge curve (generally showing the limit of use of a turbo-compressor) showing changes in the supercharged pressure versus delivery air amount of the turbo-compressor. This makes it possible to improve performance of the turbo-compressor at high speeds and also improve reliability of the blades.

While the above embodiment is shown as an example in which the inside diameter of the opening 16 of the center cavity 13 is formed smaller than other parts, the center cavity 13 may also be formed with its inside round surface diameter almost constant from the opening to the bottom. Employing this constitution simplifies the form of the center cavity 13 so that it is formed easily and the manufacturing cost of the piston 4 is reduced.

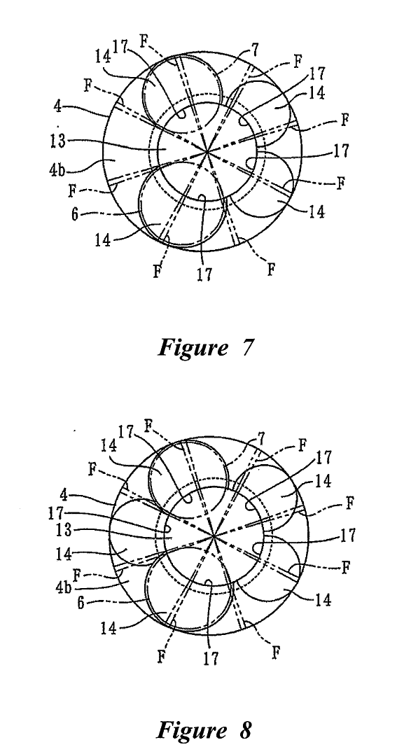

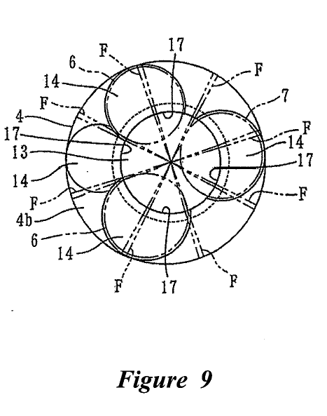

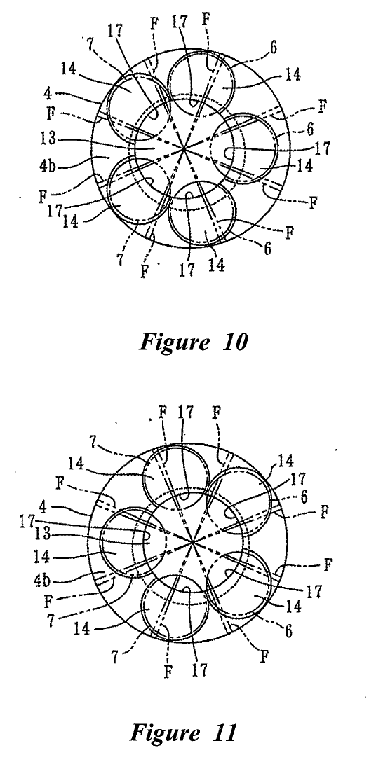

While a multi-cylinder, direct injection type of diesel engine is described above as an example of embodiment, this invention may be applied to a single-cylinder, direct injection diesel engine. In addition, while the illustrated direct injection diesel engine is shown with two each of the intake and the exhaust valves for each cylinder, the number of intake and exhaust valves is not limited to the above. For example, it is also possible to apply this invention to: a diesel engine such as that shown in FIGS. 7 and 8 in which one each of intake and exhaust valves are provided for each cylinder; a diesel engine as shown in FIG. 9 in which two intake valves 6, 6 and one exhaust valve 7 are provided for each cylinder; a diesel engine such as that shown in FIG. 10 in which three intake valves 6, 6, 6 and two exhaust valves 7, 7 are provided for each cylinder; and a diesel engine such as that shown in FIG. 11 in which two intake valves 6, 6 and three exhaust valves 7, 7, 7 are provided for each cylinder.

In case one each of the intake and the exhaust valves are provided, like the form shown in FIGS. 1 to 3, the sub-cavities 14 are preferably provided in four positions in the head 4a of the piston 4 for the purpose of improving combustion. In that case, the sub-cavities 14 are also formed in parts of the head 4a of the piston 4 that do not face the intake and exhaust valves 6 and 7. As shown in FIG. 7, in case the intake and exhaust valves 6, 7 are provided only on one side of the head 4a of the piston 4, the sub-cavities 14 may be provided also in parts of the head 4a of the piston 4 that is on the opposite side of the intake and exhaust valves 6, 7, and that do not face the intake and exhaust valves 6, 7.

In case the diesel engine is provided with two intake valves 6, 6 and one exhaust valve 7 for each cylinder, as shown in FIG. 9, a sub-cavity 14 may also be formed in a part of the head 4a of the piston 4 facing an area between two intake valves 6, 6.

In case each cylinder is provided with three intake valves 6 and two exhaust valves 7, or with two intake valves 6 and three exhaust valves 7, as shown in FIGS. 10 and 11, sub-cavities 14 can be formed in parts of the head 4a of the piston 4 facing respectively the intake and exhaust valves 6, 7.

In addition, the above-described embodiment is an example of using the variable valve timing device 12 adapted to change the exhaust camshaft rotation phase. However, a variable valve timing device may be used that makes it possible to change separately the opening time and the closing time of the exhaust valve 7. When a variable valve timing device of such a configuration is used, a configuration may be used in which only the exhaust valve closing time is delayed while holding the exhaust valve opening time unchanged when the engine is in a low speed operation range.

Although the present invention has been described in terms of certain embodiments and implementations, other embodiments and implementations apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

1. A direct injection type of diesel engine comprising;
a piston comprising a center cavity, the center cavity comprising a circular recess formed in a head of the piston, and
an injector configured to directly inject fuel into the center cavity, wherein
sub-cavities are formed in the peripheral side of the head and connected to the center cavity, and
the injector is positioned to inject fuel toward a border portion between the sub-cavities and the center cavity.

2. The direct injection type of diesel engine of claim 1, wherein
the sub-cavities are formed in a recess on the peripheral side of the piston head, facing valve bodies of intake and exhaust valves and the sub-cavities having a shape similar to the valve body, deeper and radially greater than the recess.

3. The direct injection type of diesel engine of claim 1, wherein
an inside diameter of an opening of the center cavity is smaller than an inside diameter of an interior of the cavity.

4. The direct injection type of diesel engine of claim 3, wherein
a bottom of the center cavity is formed in a quasi conical shape convex toward a cylinder head and a bottom of the sub-cavity is formed at a nearly same height as an apex of the bottom of the center cavity.

5. The direct injection type of diesel engine of claim 1, wherein
an inside round surface of the center cavity is formed with a nearly constant inside diameter from the opening to the bottom.

6. The direct injection type of diesel engine of claim 1, further comprising a variable valve timing device for exhaust valve, wherein
the variable valve timing device delays the exhaust valve closing time when the engine is in a low speed operation range so that the valve overlap is 60 degrees or greater in crank angle, and advances the exhaust valve opening time when the engine is in transition from the low to a high speed operation range.

7. A direct injection type of diesel engine comprising a piston, said piston comprising a head, said head comprising an upper surface and a peripheral side surface, a center cavity defined along an axial center of the head and extending into the head from the upper surface, a sub-cavity positioned between the peripheral side surface and the center cavity and extending into the head from the upper surface, the sub-cavity being connected to the center cavity, a border portion defined at an intersection between the center cavity and the sub-cavity and an injector positioned to directly inject fuel toward the border portion.
